(19) United States
(12) Patent Application Publication
(10) Pub. No.: US 2011/0216915 A1
(43) Pub. Date: Sep. 8, 2011

(54) PROVIDING AUDIBLE INFORMATION TO A SPEAKER SYSTEM VIA A MOBILE COMMUNICATION DEVICE

(75) Inventors: Nader Gharachorloo, Ossining, NY (US); Michelle Felt, Randolph, NJ (US)

(73) Assignee: VERIZON PATENT AND LICENSING, INC., Basking Ridge, NJ (US)

(21) Appl. No.: 12/719,245

(22) Filed: Mar. 8, 2010

(51) Int. Cl. H04R 27/00; H04B 7/00

(52) U.S. Cl. 381/82; 455/41.3

(57) ABSTRACT

A mobile communication device connects with a computing device via short range wireless signaling provided between the mobile communication device and the computing device, and receives audible information from a user of the mobile communication device. The mobile communication device also encodes the audible information at a particular audio bandwidth, and provides the encoded audible information to the computing device, where the computing device outputs the encoded audible information.

### BACKGROUND

A wireless microphone may be used for public speaking (e.g., for public address systems), karaoke singing, etc. For example, public address systems may include a microphone wirelessly connected to one or more speakers. A user may speak into the microphone, the user's voice may be wirelessly transmitted to the speakers, and the speakers may output the user's voice. Such arrangements may be used when giving a lecture, giving a presentation, addressing an audience, etc.

### BRIEF DESCRIPTION OF THE DRAWINGS

FIG. 1 is a diagram of an exemplary network in which systems and/or methods described herein may be implemented;

FIG. 2 is a diagram of exemplary components of one of the devices depicted in FIG. 1;

FIG. 3 is a diagram of exemplary operations capable of being performed by an exemplary portion of the network depicted in FIG. 1;

FIG. 4 is a diagram of exemplary operations capable of being performed by another exemplary portion of the network depicted in FIG. 1;

FIGS. 5A-5D are diagrams of exemplary user interfaces capable of being generated by the user device depicted in FIG. 1;

FIG. 6 is a diagram of exemplary operations capable of being performed by still another exemplary portion of the network depicted in FIG. 1;

FIG. 7 is a diagram of exemplary operations capable of being performed by a further exemplary portion of the network depicted in FIG. 1;

FIGS. 8-10 are flow charts of an exemplary process for providing audible information to a speaker system via a mobile communication device according to implementations described herein; and

FIG. 11 is a flow chart of an exemplary process for providing a public announcement to multiple computing/media devices via a mobile communication device according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may enable a user device (e.g., a mobile communication device) to provide audible information to a speaker system. In one implementation, for example, a mobile communication device may receive, from a user, a request to connect to a computing/media device, and may connect, via short range wireless signaling, with the computing/media device based on the request. The mobile communication device may receive audible information from the user, and may encode the audible information to preserve the quality of the audible information. The mobile communication device may provide the encoded audible information to the computing/media device, and the computing/media device may output audible sound based on the encoded audible information.

As used herein, the term “user” is intended to be broadly interpreted to include a user device or a user of a user device.

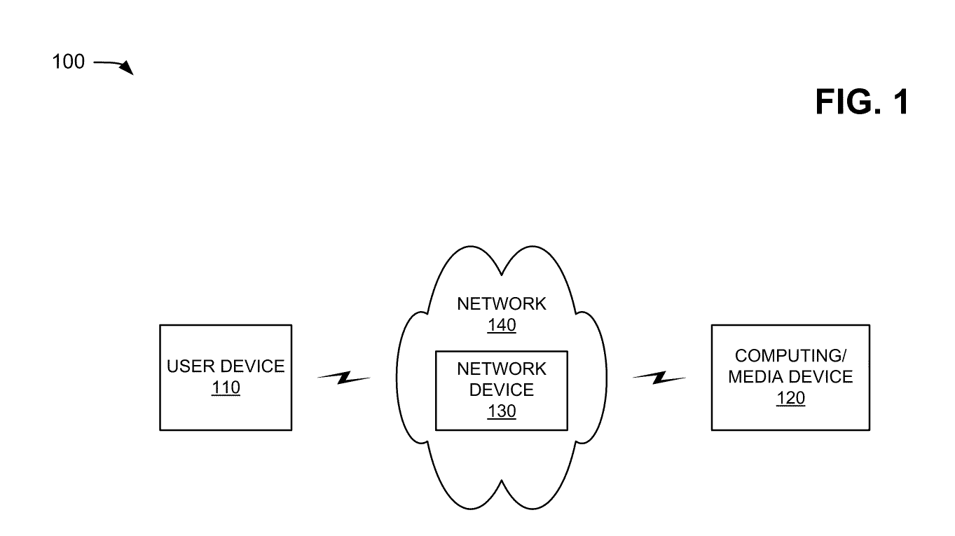

FIG. 1 is a diagram of an exemplary network 100 in which systems and/or methods described herein may be implemented. As illustrated, network 100 may include a user device 110 and a computing/media device 120 interconnected by a network 140 (e.g., via a network device 130). Components of network 100 may interconnect via wired and/or wireless connections. A single user device 110, computing/media device 120, network device 130, and network 140 have been illustrated in FIG. 1 for simplicity. In practice, there may be more user devices 110, computing/media devices 120, network devices 130, and/or networks 140. Also, in some instances, one or more of the components of network 100 may perform one or more functions described as being performed by another one or more of the components of network 100.

User device 110 may include any mobile communication device that is capable of communicating with computing/media device 120 directly (e.g., via Bluetooth wireless signals, WiFi signals, etc.) and/or via network 140 (e.g., via communication with network device 130). For example, user device 110 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a wireless device (e.g., a wireless telephone), a cellular telephone, a smart phone, or other types of mobile communication devices.

In one exemplary implementation, user device 110 may receive, from a user, a request to connect to computing/media device 120, and may connect, via short range wireless signaling, with computing/media device 120 based on the request. Alternatively, user device 110 may automatically connect to computing/media device 120 when user device 110 and computing/media device 120 are less than a particular distance from each other (e.g., via Bluetooth wireless signals, WiFi signals, etc.). User device 110 may receive audible information from the user, and may encode the audible information (e.g., at an audio bandwidth of more than three (3) kilohertz (kHz)) to preserve the quality of the audible information. User device 110 may provide the encoded audible information to computing/media device 120, and computing/media device 120 may output the encoded audible information.

Computing/media device 120 may include a device that is capable of communicating with user device 110 directly (e.g., via Bluetooth wireless signals, WiFi wireless signals, etc.) and/or via network 140 (e.g., via communication with network device 130). For example, computing/media device 120 may include a laptop computer, a personal computer, a set-top box (STB), a television, a stereo, a public address system, one or more speakers, a gaming system, etc. In one exemplary implementation, computing/media device 120 may wirelessly communicate with user device 110, and may receive encoded audible information from user device 110. Computing/media device 120 may output (e.g., via one or more speakers) the encoded audible information.

Network device 130 may include may include a data transfer device, such as a gateway, a router, a switch, a firewall, a network interface card (NIC), a hub, a bridge, a proxy server, an optical add-drop multiplexer (OADM), or some other type of device that processes and/or transfers information. In an implementation, network device 130 may include a device that is capable of transmitting information to and/or receiving information from user device 110 and/or computing/media device 120.

Network 140 may include a local area network (LAN), a Wi-Fi network, an intranet, a Bluetooth network, and/or other short range networks.

Although FIG. 1 shows exemplary components of network 100, in other implementations, network 100 may contain fewer components, different components, differently arranged components, or additional components than depicted in FIG. 1.

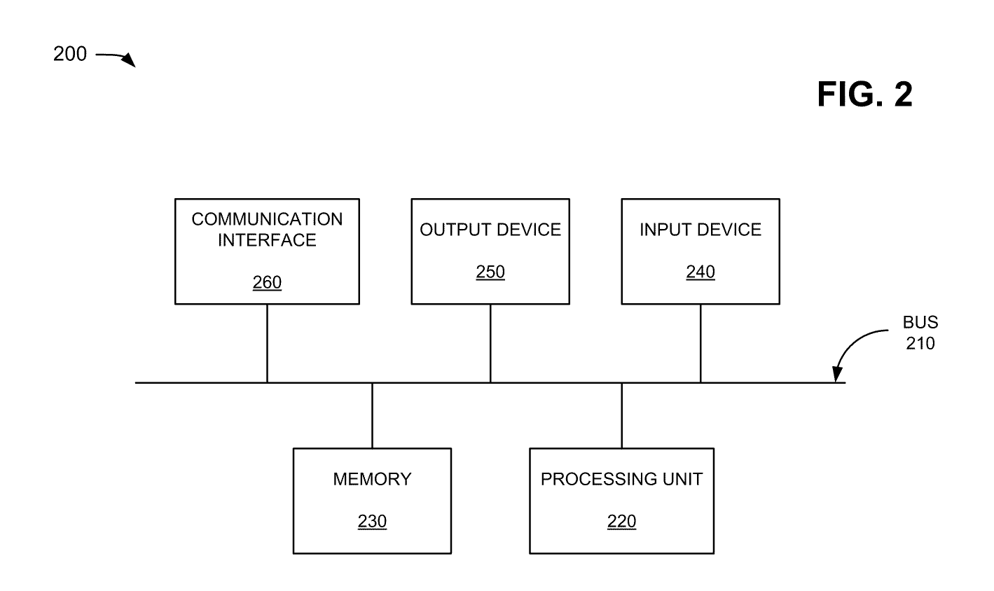

FIG. 2 is a diagram of exemplary components of a device 200 that may correspond to one of the devices of network 100. As illustrated, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. In other implementations, processing unit 220 may be implemented as or include one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits an operator to input information to device 200, such as a keyboard, a keypad, a mouse, a pen, a microphone, one or more biometric mechanisms, and the like. Output device 250 may include a device that outputs information to the operator, such as a display, a speaker, etc.

Communication interface 260 may include any transceiver-like mechanism that enables device 200 to communicate with other devices and/or systems. For example, communication interface 260 may include mechanisms for communicating with other devices, such as other devices of network 100.

As described herein, device 200 may perform certain operations in response to processing unit 220 executing software instructions contained in a computer-readable medium, such as memory 230. A computer-readable medium may be defined as a physical or logical memory device. A logical memory device may include memory space within a single physical memory device or spread across multiple physical memory devices. The software instructions may be read into memory 230 from another computer-readable medium or from another device via communication interface 260. The software instructions contained in memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer components, different components, differently arranged components, or additional components than depicted in FIG. 2. In still other implementations, one or more components of device 200 may perform one or more other tasks described as being performed by one or more other components of device 200.

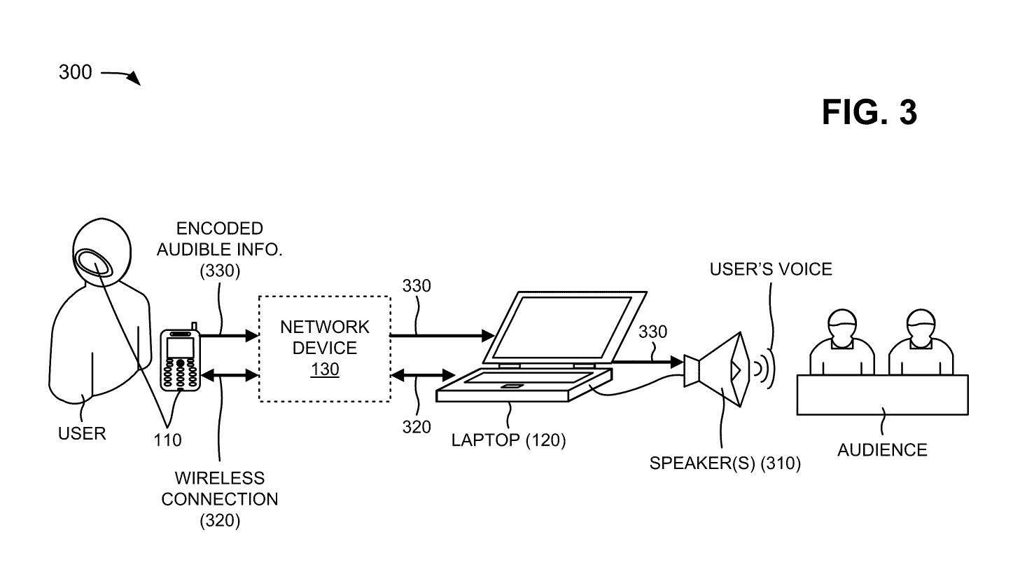

FIG. 3 is a diagram of exemplary operations capable of being performed by an exemplary portion 300 of network 100. As shown, exemplary network portion 300 may include user device 110, computing/media device 120, and network device 130. User device 110, computing/media device 120, and network device 130 may include the features described above in connection with one or more of FIGS. 1 and 2. In one example, user device 110 may include a cellular telephone with a wireless headset, and computing/media device 120 may include a laptop computer that connects to one or more speakers 310. Speakers 310 may include a device that provides audible information to one or more persons (e.g., an audience).

As further shown in FIG. 3, a user of user device 110 (e.g., cellular telephone) may request that user device 110 establish a short range wireless connection 320 with laptop computer 120. In one example, user device 110 may establish short range wireless connection 320 with laptop computer 120 via network device 130 (e.g., a wireless router). In another example, the user may not request that user device 110 establish short range wireless connection 320 with laptop computer 120, but rather user device 110 may automatically establish short range wireless connection 320 with laptop computer 120 (e.g., via Bluetooth wireless signals, WiFi wireless signals, etc.). For example, user device 110 may transmit a wireless signal (e.g., identifying user device 110) to laptop computer 120, and may receive a wireless signal (e.g., identifying laptop computer 120) from laptop computer 120. User device 110 and laptop computer 120 may establish short range wireless connection 320 based on the exchanged wireless signals. In such an arrangement, network device 130 (and network 140) may or may not be omitted from network portion 300.

The user may provide audible information (e.g., the user's voice) to user device 110 (e.g., by speaking into the wireless headset). User device 110 may receive the audible information, and may encode the audible information to produce encoded audible information 330. In one example, encoded audible information 330 may include audible information encoded at an audio bandwidth greater than the audio bandwidth used for telephone signals (e.g., greater than three kHz). In one exemplary implementation, user device 110 may compress the audible information in accordance with the Evolution-Data Optimized (EVDO) telecommunications standard in order to produce encoded audible information 330. User device 110 may provide encoded audible information 330 to laptop computer 120 via network device 130 (or directly if network device 130 is omitted).

Laptop computer 120 may receive encoded audible information 330, and may provide encoded audible information 330 to speakers 310. Speakers 310 may receive encoded audible information 330, and may output audible sound based on encoded audible information 330. For example, speakers 310 may output the user's voice to the audience. In such an arrangement, user device 110 (e.g., the cellular telephone) may function as a microphone in a manner similar to a wireless microphone in a public address system. The user may speak into the cellular telephone and the audience may hear the user's voice (e.g., via laptop computer 120 and speakers 310).

Although FIG. 3 shows exemplary components of network portion 300, in other implementations, network portion 300 may contain fewer components, different components, differently arranged components, or additional components than depicted in FIG. 3. Alternatively, or additionally, one or more components of network portion 300 may perform one or more other tasks described as being performed by one or more other components of network portion 300.

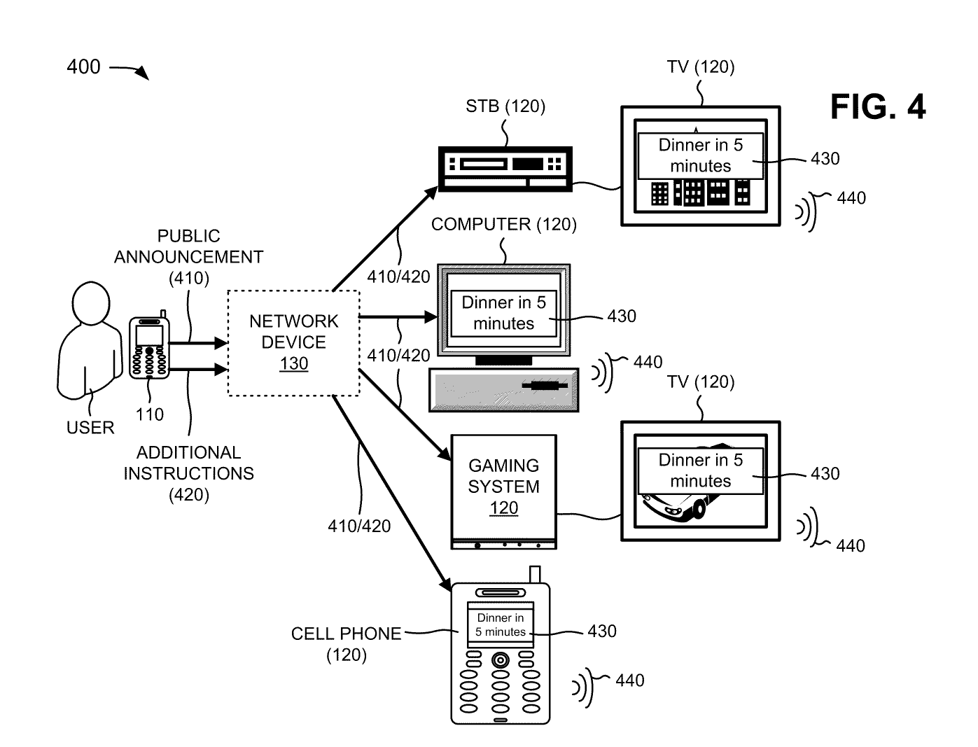

FIG. 4 is a diagram of exemplary operations capable of being performed by another exemplary portion 400 of network 100. As shown, exemplary network portion 400 may include user device 110, multiple computing/media devices 120, and network device 130. User device 110, computing/media devices 120, and network device 130 may include the features described above in connection with one or more of FIGS. 1-3. In one example, user device 110 may include a cellular telephone, and computing/media devices 120 may include a STB connected to a television (TV), a computer, a gaming system connected to a TV, and a cellular telephone.

As further shown in FIG. 4, a user of user device 110 may input a public announcement 410 into user device 110. Public announcement 410 may include an audible public announcement (e.g., “Dinner in 5 minutes”), a textual public announcement (e.g., “Time to do your homework”), etc. In one example, the user may speak public announcement 410 into user device 110, and user device 110 may convert the speech associated with public announcement 410 into textual information (e.g., via a speech recognition application provided in user device 110). In another example, the user may provide both an audible and a textual public announcement 410 into user device 110.

The user may also input additional instructions 420 into user device 110. Additional instructions 420 may include the user specifying which computing/media devices 120 are to receive public announcement 410; a time for when computing/media devices 120 are to receive public announcement 410; whether computing/media devices 120 are to be disabled after public announcement 410; whether computing/media devices 120 are to be paused during output of public announcement 410; etc. In one example, user device 110 may require permission from computing/media devices 120 to disable and/or pause computing/media devices 120. In such situations, user device 110 may be required to provide a password, account information, etc. to computing/media devices 120.

The user of user device 110 may request that user device 110 establish a short range wireless connection with each of computing/media devices 120 (e.g., STB/TV 120, computer 120, gaming system/TV 120, and cellular phone 120). In one example, user device 110 may establish a short range wireless connection with each of computing/media devices 120 via network device 130 (e.g., a wireless router). In another example, the user may not request that user device 110 establish a short range wireless connection with each of computing/media devices 120, but rather user device 110 may automatically establish a short range wireless connection with each of computing/media devices 120 (e.g., via Bluetooth wireless signals, WiFi wireless signals, etc.). For example, user device 110 may transmit a wireless signal (e.g., identifying user device 110) to computing/media devices 120, and may receive wireless signals (e.g., identifying computing/media devices 120) from computing/media devices 120. User device 110 and computing/media devices 120 may establish short range wireless connections based on the exchanged wireless signals. In such an arrangement, network device 130 (and network 140) may or may not be omitted from network portion 400.

As further shown in FIG. 4, user device 110 may provide public announcement 410 and additional instructions 420 to computing/media devices 120 via network device 130 (or directly if network device 130 is omitted). Computing/media devices 120 may receive public announcement 410 and additional instructions 420, and may output public announcement 410 in accordance with additional instructions 420. For example, STB/television 120 may textually display public announcement 410 as a pop-up window 430 (e.g., overlying television programming provided on TV 120) and/or may audibly provide public announcement 410, as indicated by reference number 440. Computer 120 may textually display public announcement 410 as pop-up window 430 (e.g., overlying information provided on computer 120) and/or may audibly provide public announcement 410, as indicated by reference number 440. Gaming system/television 120 may textually display public announcement 410 as pop-up window 430 (e.g., overlying a video game provided on TV 120) and/or may audibly provide public announcement 410, as indicated by reference number 440. Cellular telephone 120 may textually display public announcement 410 as pop-up window 430 (e.g., provided on a display of cellular telephone 120) and/or may audibly provide public announcement 410, as indicated by reference number 440. In other implementations, computing/media devices 120 may output public announcement 410 in other ways (e.g., via a full screen display).

In one exemplary implementation, the user (e.g., via user device 110) may provide a different public announcement 410 (e.g., at the same time or at different times) to different computing/media devices 120. For example, user device 110 may provide a first public announcement 410 to STB/TV 120 (e.g., “TV will turn off in ten minutes”), a second public announcement 410 to computer 120 (e.g., “You have been on the computer for one hour”), a third public announcement 410 to gaming system/TV 120 (e.g., “Your thirty minutes of game time is over”), and a fourth public announcement 410 to cellular telephone 120 (e.g., “It is past 10:00 PM, no more text messaging”).

Although FIG. 4 shows exemplary components of network portion 400, in other implementations, network portion 400 may contain fewer components, different components, differently arranged components, or additional components than depicted in FIG. 4. Alternatively, or additionally, one or more components of network portion 400 may perform one or more other tasks described as being performed by one or more other components of network portion 400.

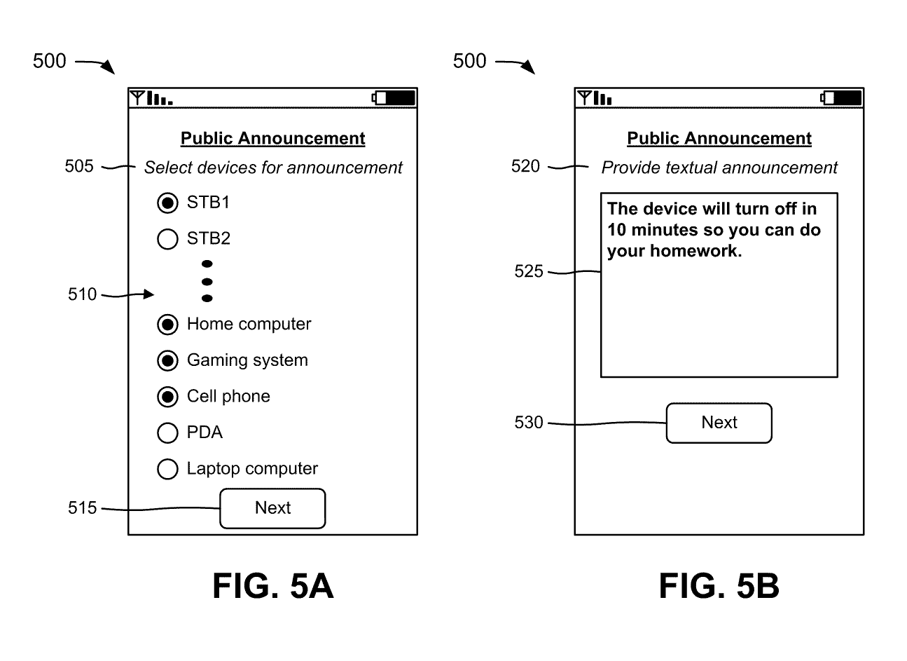

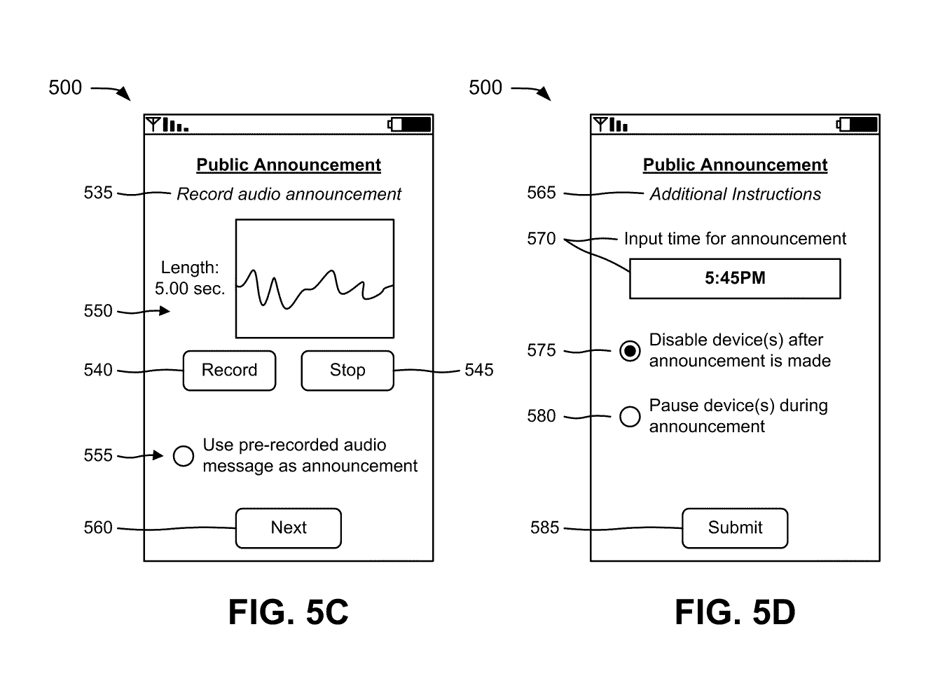

FIGS. 5A-5D are diagrams of exemplary user interfaces 500 capable of being generated by user device 110. User interfaces 500 may include graphical user interfaces (GUIs) or non-graphical user interfaces, such as text-based interfaces. User interfaces 500 may provide information to users via customized interfaces (e.g., proprietary interfaces) and/or other types of interfaces (e.g., browser-based interfaces, etc.). User interfaces 500 may receive user inputs via one or more input devices, may be user-configurable (e.g., a user may change the size of user interfaces 500, information displayed in user interfaces 500, color schemes used by user interfaces 500, positions of text, images, icons, windows, etc., in user interfaces 500, etc.), and/or may not be user-configurable. Information associated with user interfaces 500 may be selected and/or manipulated by a user of user device 110 (e.g., via a touch screen display, control buttons, and/or a keypad).

As shown in FIG. 5A, user interface 500 may present various applications to a user, such as a public announcement application. The public announcement application may enable a user to provide public announcement 410 and/or additional instructions 420 (FIG. 4) to user device 110. The public announcement application may present an option 505 to select one or more devices (e.g., computing/media devices 120) that are to receive a public announcement. Option 505 may provide a list 510 of one or more devices that may be selected (e.g., via a selection mechanism, such as a radio button, a drop-down menu, a check box, etc.) by a user of user device 110.

Once the user has selected one or more devices from list 510, the user may select a next button 515 and user interface 500 may present the information depicted in FIG. 5B. As shown in FIG. 5B, user interface 500 may present an option 515 to provide a textual announcement (e.g., as public announcement 410). The textual announcement may be provided by the user (e.g., to user device 110) via a textual input window 525. For example, the user may provide a message (e.g., “The device will turn off in 10 minutes so you can do your homework.”) in textual input window 525. The user may edit or erase some (or all of) the textual announcement provided in textual input window 525.

Once the user is satisfied with the textual announcement provided in textual input window 525, the user may select a next button 530 and user interface 500 may present the information depicted in FIG. 5C. As shown in FIG. 5C, user interface 500 may present an option 535 to record an audio announcement (e.g., as public announcement 410). In one example, the user may select a record button 540, may speak the audio announcement (e.g., into a microphone of user device 110), and may select a stop button 545 when the audio announcement is complete. User interface 500 may provide a visual indication of the audio announcement and a time length of the audio announcement, as indicated by reference number 550. Alternatively, instead of recording the audio announcement, the user may use a pre-recorded audio message as the announcement by selecting a mechanism 555 (e.g., a radio button, a drop-down menu, a check box, etc.). If mechanism 555 is selected, user device 110 may present a list (not shown) of pre-recorded audio messages from which the user may choose.

Once the user has recorded the audio announcement (or selected a pre-recorded audio message), the user may select a next button 560 and user interface 500 may present the information depicted in FIG. 5D. As shown in FIG. 5D, user interface 500 may present an option 565 to provide additional instructions associated with a public announcement. In one example, the user may input a time (e.g., “5:45 PM”) for a public announcement via time input window 570. The time provided in time input window 570 may correspond to a time that user device 110 provides a public announcement (e.g., public announcement 410) to computing/media device(s) 120, a time that computing/media device(s) 120 are to output the public announcement, etc. In another example, the user may disable computing/media device(s) 120 after the public announcement is made by selecting a mechanism 575 (e.g., a radio button, a drop-down menu, a check box, etc.). If the user selects mechanism 575, user device 110 may provide an instruction (e.g., via additional instructions 420 (FIG. 4)) to computing/media device(s) 120 that instructs computing/media device(s) 120 to become disabled (e.g., to turn off, shut down, etc.) after the public announcement is made. Such functionality may enable, for example, parents to provide particular time limits on use of computing/media device(s) 120 by their children (e.g., time limits on computer use, cellular telephone use, video game use, etc.).

In still another example, the user may pause computing/media device(s) 120 while the public announcement is made by selecting a mechanism 580 (e.g., a radio button, a drop-down menu, a check box, etc.). If the user selects mechanism 580, user device 110 may provide an instruction (e.g., via additional instructions 420 (FIG. 4)) to computing/media device(s) 120 that instructs computing/media device(s) 120 to pause while the public announcement is made. Once the user has provided the additional instructions (e.g., via user interface 500 depicted in FIG. 5D), the user may select a submit button 585 and user device 110 may provide the public announcement (e.g., public announcement 410) and/or the additional instructions (e.g., additional instructions 420) to computing/media device(s) 120.

Although user interfaces 500 of FIGS. 5A-5D depict a variety of information, in other implementations, user interfaces 500 may depict less information, different information, differently arranged information, or additional information than depicted in FIGS. 5A-5D.

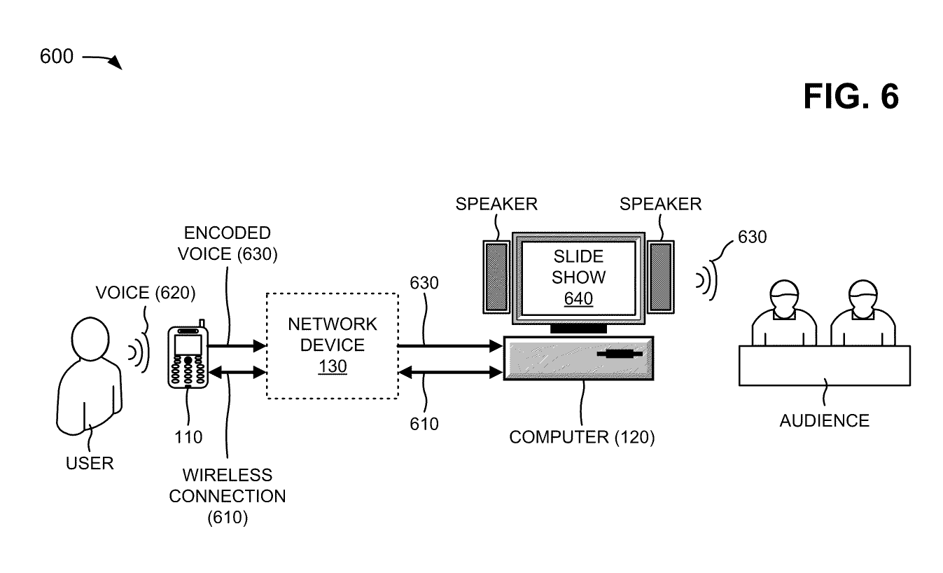

FIG. 6 is a diagram of exemplary operations capable of being performed by still another exemplary portion 600 of network 100. As shown, exemplary network portion 600 may include user device 110, computing/media device 120, and network device 130. User device 110, computing/media device 120, and network device 130 may include the features described above in connection with one or more of FIGS. 1-5D. In one example, user device 110 may include a cellular telephone, and computing/media device 120 may include a computer.

As further shown in FIG. 6, a user of user device 110 may request that user device 110 establish a short range wireless connection 610 with computer 120. In one example, user device 110 may establish short range wireless connection 610 with computer 120 via network device 130 (e.g., a wireless router). In another example, the user may not request that user device 110 establish short range wireless connection 610 with computer 120, but rather user device 110 may automatically establish short range wireless connection 610 with computer 120 (e.g., via Bluetooth wireless signals, WiFi wireless signals, etc.). For example, user device 110 may transmit a wireless signal (e.g., identifying user device 110) to computer 120, and may receive a wireless signal (e.g., identifying computer 120) from computer 120. User device 110 and computer 120 may establish short range wireless connection 610 based on the exchanged wireless signals. In such an arrangement, network device 130 (and network 140) may or may not be omitted from network portion 600.

The user may provide audible information (e.g., the user's voice 620) to user device 110. User device 110 may receive the user's voice 620, and may encode the user's voice 620 to produce an encoded voice 630. In one example, encoded voice 630 may include the user's voice 620 encoded at an audio bandwidth greater than the audio bandwidth used for telephone signals (e.g., greater than three kHz). In one exemplary implementation, user device 110 may compress the user's voice 620 in accordance with the EVDO telecommunications standard in order to produce encoded voice 630. User device 110 may provide encoded voice 630 to computer 120 via network device 130 (or directly if network device 130 is omitted).

Computer 120 may receive encoded voice 630, and may provide encoded voice 630 to speakers of computer 120. The speakers of computer 120 may receive encoded voice 630, and may output audible sound based on encoded voice 630. For example, the speakers may output the user's voice (e.g., encoded voice 630) to an audience while the user provides a presentation or a slide show 640 (e.g., provided on computer 120) to the audience. In such an arrangement, user device 110 (e.g., the cellular telephone) may function as a microphone in a manner similar to a wireless microphone in a public address system. The user may speak into the cellular telephone and the audience may hear the user's voice (e.g., via computer 120 and its speakers).

Although FIG. 6 shows exemplary components of network portion 600, in other implementations, network portion 600 may contain fewer components, different components, differently arranged components, or additional components than depicted in FIG. 6. Alternatively, or additionally, one or more components of network portion 600 may perform one or more other tasks described as being performed by one or more other components of network portion 600.

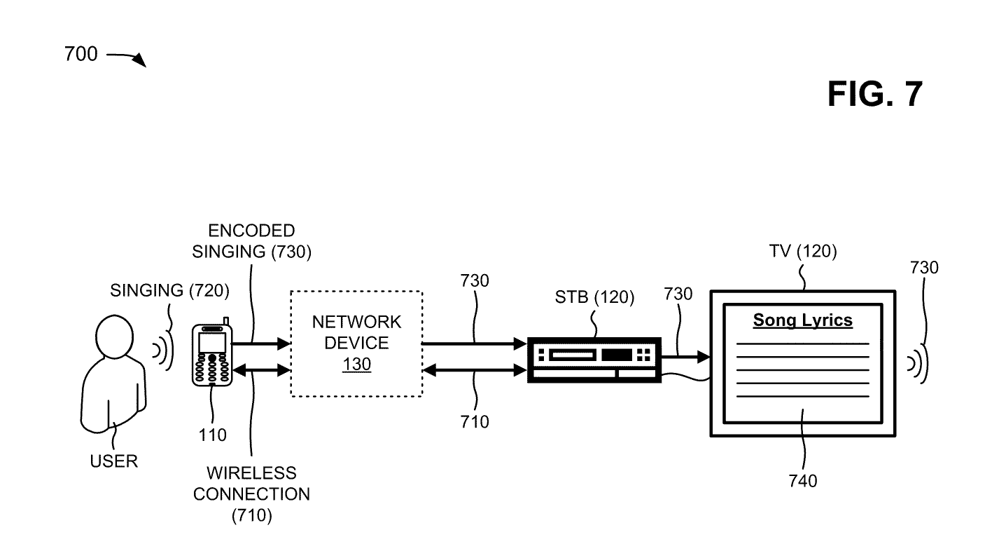

FIG. 7 is a diagram of exemplary operations capable of being performed by a further exemplary portion 700 of network 100. As shown, exemplary network portion 700 may include user device 110, computing/media device 120, and network device 130. User device 110, computing/media device 120, and network device 130 may include the features described above in connection with one or more of FIGS. 1-6. In one example, user device 110 may include a cellular telephone, and computing/media device 120 may include a STB interconnected with a TV.

As further shown in FIG. 7, a user of user device 110 may request that user device 110 establish a short range wireless connection 710 with STB 120. In one example, user device 110 may establish short range wireless connection 710 with STB 120 via network device 130 (e.g., a wireless router). In another example, the user may not request that user device 110 establish short range wireless connection 710 with STB 120, but rather user device 110 may automatically establish short range wireless connection 710 with STB 120 (e.g., via Bluetooth wireless signals, WiFi wireless signals, etc.). For example, user device 110 may transmit a wireless signal (e.g., identifying user device 110) to STB 120, and may receive a wireless signal (e.g., identifying STB 120) from STB 120. User device 110 and STB 120 may establish short range wireless connection 710 based on the exchanged wireless signals. In such an arrangement, network device 130 (and network 140) may or may not be omitted from network portion 700.

The user may provide audible information (e.g., the user's singing 720) to user device 110. User device 110 may receive the user's singing 720, and may encode the user's singing 720 to produce encoded singing 730. In one example, encoded singing 730 may include the user's singing 720 encoded at an audio bandwidth greater than the audio bandwidth used for telephone signals (e.g., greater than three kHz). In one exemplary implementation, user device 110 may compress the user's singing 720 in accordance with the EVDO telecommunications standard in order to produce encoded singing 730. User device 110 may provide encoded singing 730 to STB 120 via network device 130 (or directly if network device 130 is omitted).

STB 120 may receive encoded singing 730, and may provide encoded singing 730 to television 120. Television 120 may receive encoded singing 730, and may output audible sound based on encoded singing 730 (e.g., via speakers of television 120). For example, the speakers of television 120 may output the user's singing (e.g., encoded singing 730) as the user sings song lyrics 740 displayed on television 120. In such an arrangement, user device 110 (e.g., the cellular telephone) may function as a microphone in a manner similar to a wireless microphone in a karaoke system. The user may sing into the cellular telephone and may hear the singing (e.g., via the speakers of television 120).

Although FIG. 7 shows exemplary components of network portion 700, in other implementations, network portion 700 may contain fewer components, different components, differently arranged components, or additional components than depicted in FIG. 7. Alternatively, or additionally, one or more components of network portion 700 may perform one or more other tasks described as being performed by one or more other components of network portion 700.

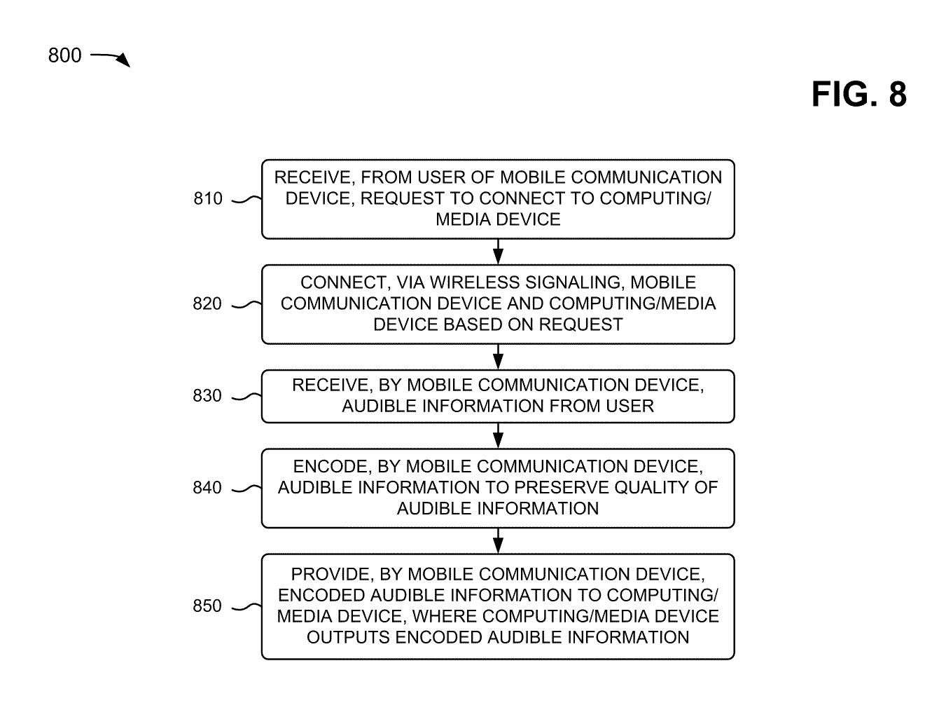

FIGS. 8-10 are flow charts of an exemplary process for providing audible information to a speaker system via a mobile communication device according to implementations described herein. In one implementation, process 800 may be performed by user device 110. In another implementation, some or all of process 800 may be performed by another device or group of devices, including or excluding user device 110.

As illustrated in FIG. 8, process 800 may include receiving, from a user of a mobile communication device, a request to connect to a computing/media device (block 810), and connecting, via short range wireless signaling, the mobile communication device and the computing/media device based on the request (block 820). For example, in implementations described above in connection with FIG. 3, a user of user device 110 may request that user device 110 establish short range wireless connection 320 with laptop computer 120. In one example, user device 110 may establish short range wireless connection 320 with laptop computer 120 via network device 130 (e.g., a wireless router). In another example, the user may not request that user device 110 establish short range wireless connection 320 with laptop computer 120, but rather user device 110 may automatically establish short range wireless connection 320 with laptop computer 120 (e.g., via Bluetooth wireless signals, WiFi wireless signals, etc.). User device 110 may transmit a wireless signal (e.g., identifying user device 110) to laptop computer 120, and may receive a wireless signal (e.g., identifying laptop computer 120) from laptop computer 120. User device 110 and laptop computer 120 may establish short range wireless connection 320 based on the exchanged wireless signals. In such an arrangement, network device 130 (and network 140) may or may not be omitted from network portion 300.

As further shown in FIG. 8, process 800 may include receiving, by the mobile communication device, audible information from the user (block 830), and encoding, by the mobile communication device, the audible information to preserve the quality of the audible information (block 840). For example, in implementations described above in connection with FIG. 3, the user may provide audible information (e.g., the user's voice) to user device 110 (e.g., by speaking into the wireless headset). User device 110 may receive the audible information, and may encode the audible information to produce encoded audible information 330. In one example, encoded audible information 330 may include audible information encoded at an audio bandwidth greater than the audio bandwidth used for telephone signals (e.g., greater than three kHz). In another example, user device 110 may compress the audible information in accordance with the EVDO telecommunications standard in order to produce encoded audible information 330. User device 110 may provide encoded audible information 330 to laptop computer 120 via network device 130 (or directly if network device 130 is omitted).

Returning to FIG. 8, process 800 may include providing, by the mobile communication device, the encoded audible information to the computing/media device, where the computing/media device outputs the encoded audible information (block 850). For example, in implementations described above in connection with FIG. 3, laptop computer 120 may receive encoded audible information 330, and may provide encoded audible information 330 to speakers 310. Speakers 310 may receive encoded audible information 330, and may output audible sound based on encoded audible information 330. In one example, speakers 310 may output the user's voice to the audience. In such an arrangement, user device 110 (e.g., the cellular telephone) may function as a microphone in a manner similar to a wireless microphone in a public address system. The user may speak into the cellular telephone and the audience may hear the user's voice (e.g., via laptop computer 120 and speakers 310).

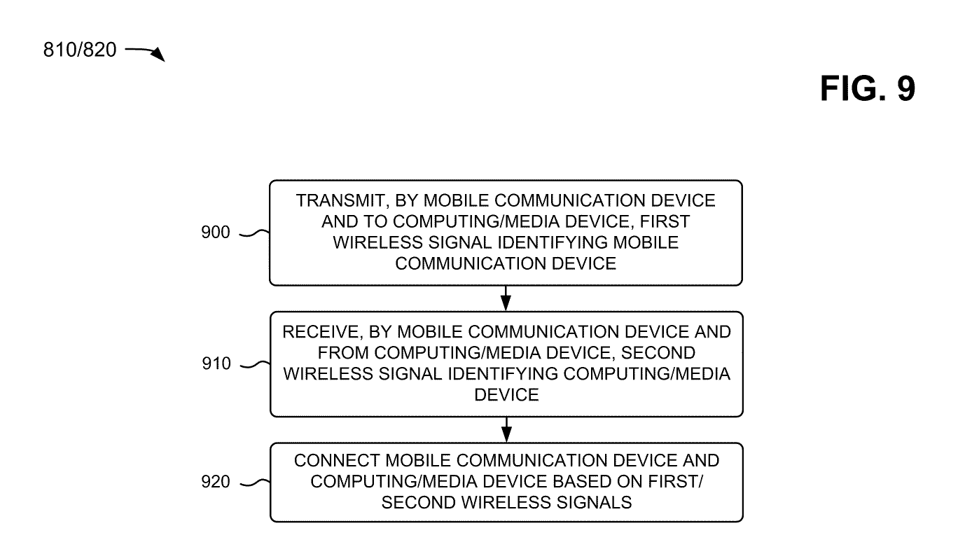

Process blocks 810/820 may include the process blocks illustrated in FIG. 9. As shown in FIG. 9, process blocks 810/820 may include transmitting, by the mobile communication device and to the computing/media device, a first wireless signal identifying the mobile communication device (block 900), receiving, by the mobile communication device and from the computing/media device, a second wireless signal identifying the computing/media device (block 910), and connecting the mobile communication device and the computing/media device based on the first and second wireless signals (block 920). For example, in implementations described above in connection with FIG. 6, the user may not request that user device 110 establish short range wireless connection 610 with computer 120, but rather user device 110 may automatically establish short range wireless connection 610 with computer 120 (e.g., via Bluetooth wireless signals, WiFi wireless signals, etc.). In one example, user device 110 may transmit a wireless signal (e.g., identifying user device 110) to computer 120, and may receive a wireless signal (e.g., identifying computer 120) from computer 120. User device 110 and computer 120 may establish short range wireless connection 610 based on the exchanged wireless signals.

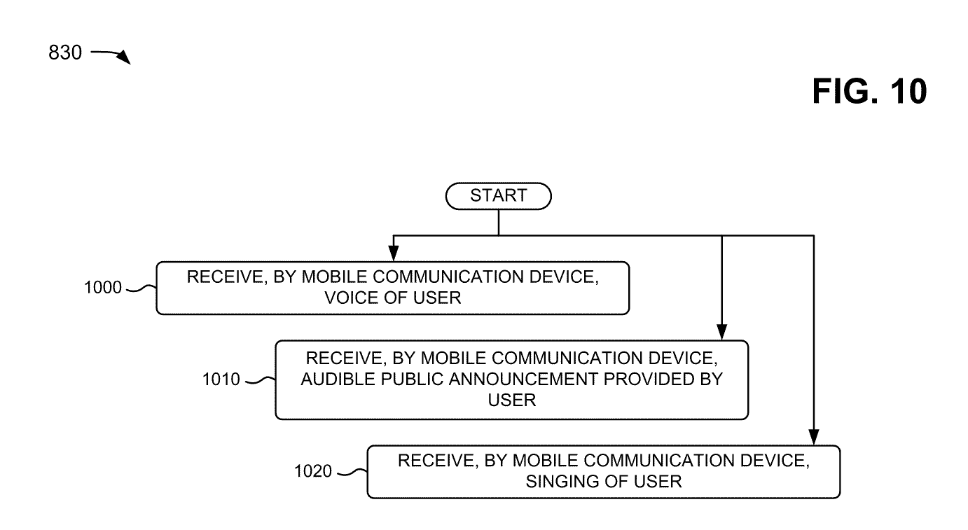

Process block 830 may include the process blocks illustrated in FIG. 10. As shown in FIG. 10, process block 830 may include one or more of receiving, by the mobile communication device, a voice of the user (block 1000), receiving, by the mobile communication device, an audible public announcement provided by the user (block 1010), and receiving, by the mobile communication device, singing of the user (block 1020). For example, in implementations described above in connection with FIG. 4, a user of user device 110 may input public announcement 410 into user device 110. Public announcement 410 may include an audible public announcement (e.g., “Dinner in 5 minutes”). In implementations described above in connection with FIG. 6, the user may provide audible information (e.g., the user's voice 620) to user device 110, and user device 110 may receive the user's voice 620. In implementations described above in connection with FIG. 7, the user may provide audible information (e.g., the user's singing 720) to user device 110, and user device 110 may receive the user's singing 720.

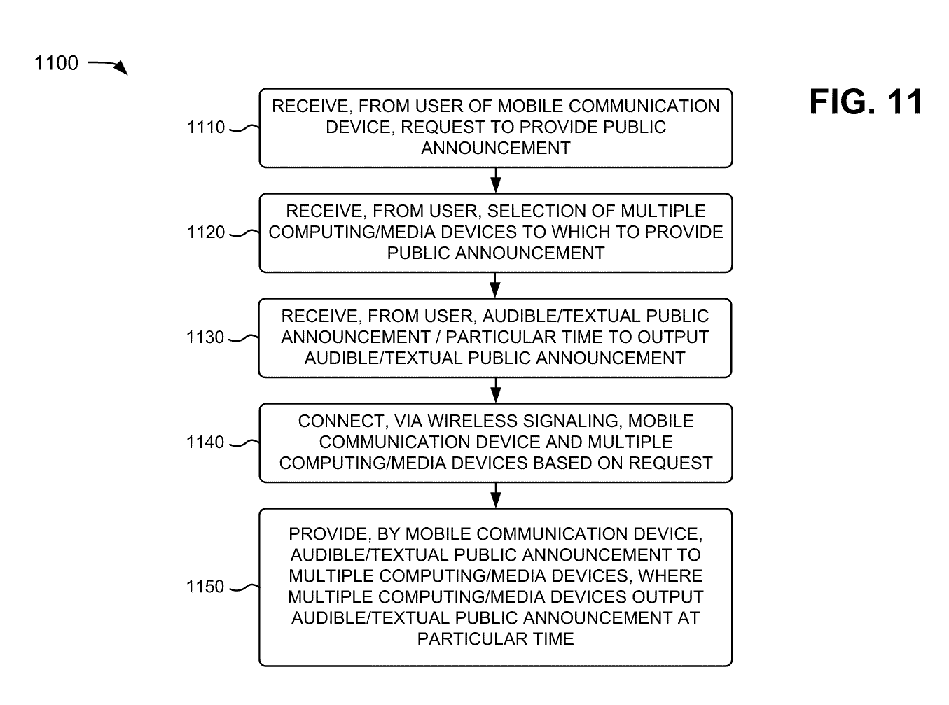

FIG. 11 is a flow chart of an exemplary process 1100 for providing a public announcement to multiple computing/media devices via a mobile communication device according to implementations described herein. In one implementation, process 1100 may be performed by user device 110. In another implementation, some or all of process 1100 may be performed by another device or group of devices, including or excluding user device 110.

As illustrated in FIG. 11, process 1100 may include receiving, from a user of a mobile communication device, a request to provide a public announcement (block 1110), and receiving, from the user, selection of multiple computing/media devices to which to provide the public announcement (block 1120). For example, in implementations described above in connection with FIGS. 4 and 5A, user interface 500 may present various applications to a user, such as a public announcement application. The public announcement application may enable a user to provide public announcement 410 and/or additional instructions 420 to user device 110. The public announcement application may present option 505 to select one or more devices (e.g., computing/media devices 120) that are to receive a public announcement. Option 505 may provide list 510 of one or more devices that may be selected (e.g., via a selection mechanism, such as a radio button, a drop-down menu, a check box, etc.) by a user of user device 110.

As further shown in FIG. 11, process 1100 may include receiving, from the user, an audible and/or a textual public announcement and a particular time to output the audible/textual public announcement (block 1130), and connecting, via short range wireless signaling, the mobile communication device and the multiple computing/media devices based on the request (block 1140). For example, in implementations described above in connection with FIGS. 4 and 5B-5D, user interface 500 may present option 515 to provide a textual announcement (e.g., as public announcement 410). The textual announcement may be provided by the user (e.g., to user device 110) via textual input window 525. User interface 500 may present option 535 to record an audio announcement (e.g., as public announcement 410). In one example, the user may select a record button 540, may speak the audio announcement (e.g., into a microphone of user device 110). The user may input a time (e.g., “5:45 PM”) for a public announcement via time input window 570. The time provided in time input window 570 may correspond to a time that user device 110 provides a public announcement (e.g., public announcement 410) to computing/media device(s) 120, a time that computing/media device(s) 120 are to output the public announcement, etc. In one example, user device 110 may establish a short range wireless connection with each of computing/media devices 120 (e.g., STB/TV 120, computer 120, gaming system/TV 120, and cellular phone 120) based on a request from the user. In another example, the user may not request that user device 110 establish a short range wireless connection with each of computing/media devices 120, but rather user device 110 may automatically establish a short range wireless connection with each of computing/media devices 120 (e.g., via Bluetooth wireless signals, WiFi wireless signals, etc.).

Returning to FIG. 11, process 1100 may include providing, by the mobile communication device, the audible/textual public announcement to the multiple computing/media devices, where the multiple computing/media devices output the audible/textual public announcement at the particular time (block 1150). For example, in implementations described above in connection with FIG. 4, user device 110 may provide public announcement 410 and additional instructions 420 to computing/media devices 120 via network device 130 (or directly if network device 130 is omitted). Computing/media devices 120 may receive public announcement 410 and additional instructions 420, and may output public announcement 410 in accordance with additional instructions 420.

Systems and/or methods described herein may enable a user device (e.g., a mobile communication device) to provide audible information to a speaker system. In one implementation, for example, a mobile communication device may receive, from a user, a request to connect to a computing/media device, and may connect, via short range wireless signaling, with the computing/media device based on the request. The mobile communication device may receive audible information from the user, and may encode the audible information to preserve the quality of the audible information. The mobile communication device may provide the encoded audible information to the computing/media device, and the computing/media device may output the encoded audible information.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 8-11, the order of the blocks may be modified in other implementations. Further, non-dependent blocks may be performed in parallel.

It will be apparent that aspects, as described herein, may be implemented in many different forms of software, firmware, and hardware in the implementations illustrated in the figures. The actual software code or specialized control hardware used to implement aspects described herein is not limiting of the invention. Thus, the operation and behavior of the aspects were described without reference to the specific software code—it being understood that software and control hardware may be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A mobile communication device-implemented method, comprising:
connecting the mobile communication device with a computing device via short range wireless signaling provided between the mobile communication device and the computing device;
receiving, by the mobile communication device, audible information from a user of the mobile communication device;
encoding, by the mobile communication device, the audible information at a particular audio bandwidth; and
providing, by the mobile communication device, the encoded audible information to the computing device,
where the computing device outputs the encoded audible information.

2. The mobile communication device-implemented method of claim 1, further comprising:
receiving, from the user, a request to connect the mobile communication device with the computing device; and
connecting the mobile communication device with the computing device based on the request.

3. The mobile communication device-implemented method of claim 1, where connecting the mobile communication device comprises:
transmitting, by the mobile communication device and to the computing device, a first wireless signal identifying the mobile communication device;
receiving, by the mobile communication device and from the computing device, a second wireless signal identifying the computing device; and
connecting the mobile communication device with the computing device based on the first and second wireless signals.

4. The mobile communication device-implemented method of claim 1, where the audible information comprises a voice of the user.

5. The mobile communication device-implemented method of claim 1, where the mobile communication device comprises one of:
a personal communications system (PCS) terminal,
a personal digital assistant (PDA), a wireless telephone,
a cellular telephone, or
a smart phone.

6. The mobile communication device-implemented method of claim 1, where the computing device comprises one of:
a laptop computer,
a personal computer,
a set-top box (STB),
a television,
a stereo,
a public address system,
a speaker, or
a gaming system.

7. A mobile communication device-implemented method, comprising:
receiving, by the mobile communication device, a request to provide a public announcement;
receiving, by the mobile communication device, selection of multiple computing devices to which to provide the public announcement;
receiving, by the mobile communication device, an audible public announcement and a particular time to output the audible public announcement;
connecting the mobile communication device with the multiple computing devices via short range wireless signaling provided between the mobile communication device and the multiple computing devices; and
providing, by the mobile communication device, the audible public announcement to the multiple computing devices,
where the multiple computing devices output the audible public announcement at the particular time.

8. The mobile communication device-implemented method of claim 7, further comprising:
receiving a textual public announcement; and
providing the textual public announcement to the multiple computing devices,
where the multiple computing devices output the textual public announcement at the particular time.

9. The mobile communication device-implemented method of claim 7, where the textual public announcement comprises a textual version of the audible public announcement.

10. The mobile communication device-implemented method of claim 7, further comprising:
receiving selection of an option to pause the multiple computing devices; and
providing, to the multiple computing devices and based on selection of the option, information instructing the multiple computing devices to pause when outputting the audible public announcement.

11. The mobile communication device-implemented method of claim 7, further comprising:
receiving selection of an option to disable the multiple computing devices; and
providing, to the multiple computing devices and based on selection of the option, information instructing the multiple computing devices to become disabled after outputting the audible public announcement.

12. The mobile communication device-implemented method of claim 7, where the audible public announcement comprises a pre-recorded audio message.

13. A mobile communication device comprising:
a memory to store a plurality of instructions; and
a processor to execute instructions in the memory to:
connect the mobile communication device with a computing device via short range wireless signaling provided between the mobile communication device and the computing device,
receive audible information from a user of the mobile communication device,
encode the audible information to preserve the quality of the audible information, and
provide the encoded audible information to the computing device,
where the computing device outputs the encoded audible information.

14. The mobile communication device of claim 13, where the encoded audible information comprises one of:
the audible information encoded at an audio bandwidth greater than three kilohertz, or
the audible information compressed in accordance with the Evolution-Data Optimized (EVDO) telecommunications.

15. The mobile communication device of claim 13, where the processor is further to execute instructions in the memory to:
receive, from the user, a request to connect the mobile communication device with the computing device, and
connect the mobile communication device with the computing device based on the request.

16. The mobile communication device of claim 13, where, when connecting the mobile communication device, the processor is further to execute instructions in the memory to:
transmit, to the computing device, a first wireless signal identifying the mobile communication device,
receive, from the computing device, a second wireless signal identifying the computing device, and
connect the mobile communication device with the computing device based on the first and second wireless signals.

17. The mobile communication device of claim 13, where the audible information comprises a voice of the user.

18. The mobile communication device of claim 13, where the mobile communication device comprises one of:
a personal communications system (PCS) terminal,
a personal digital assistant (PDA), a wireless telephone,
a cellular telephone, or
a smart phone.

19. A mobile communication device comprising:
a memory to store a plurality of instructions; and
a processor to execute instructions in the memory to:
receive, from a user of the mobile communication device, a request to provide a public announcement,
receive, from the user, selection of multiple computing devices to which to provide the public announcement,
receive, from the user, an audible public announcement and a particular time to output the audible public announcement,
connect to the multiple computing devices via short range wireless signaling provided between the mobile communication device and the multiple computing devices, and
provide the audible public announcement to the multiple computing devices,
where the multiple computing devices output the audible public announcement at the particular time.

20. The mobile communication device of claim 19, where the processor is further to execute instructions in the memory to:
receive, from the user, a textual public announcement, and
provide the textual public announcement to the multiple computing devices,
where the multiple computing devices output the textual public announcement at the particular time.

21. The mobile communication device of claim 19, where the textual public announcement comprises a textual version of the audible public announcement.

22. The mobile communication device of claim 19, where the processor is further to execute instructions in the memory to:
receive, from the user, selection of an option to pause the multiple computing devices, and
provide, to the multiple computing devices and based on selection of the option, information instructing the multiple computing devices to pause when outputting the audible public announcement.

23. The mobile communication device of claim 19, where the processor is further to execute instructions in the memory to:
receive, from the user, selection of an option to disable the multiple computing devices, and
provide, to the multiple computing devices and based on selection of the option, information instructing the multiple computing devices to become disabled after outputting the audible public announcement.

24. The mobile communication device of claim 19, where the audible public announcement comprises a pre-recorded audio message.

25. The mobile communication device of claim 19, where the mobile communication device comprises one of:
a personal communications system (PCS) terminal,
a personal digital assistant (PDA), a wireless telephone,
a cellular telephone, or
a smart phone.
